(19) United States
(12) Patent Application Publication
(10) Pub. No.: US 2008/0077913 A1
(43) Pub. Date: Mar. 27, 2008

(54) Information recording medium, apparatus and method of reproducing contents

(75) Inventors: Chang-sup Ahn, Seoul (KR); Yong-kuk You, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/783,776

(22) Filed: Apr. 12, 2007

Related U.S. Application Data
(60) Provisional application No. 60/846,359, filed on Sep. 22, 2006.

(30) Foreign Application Priority Data
Oct. 20, 2006 (KR) 10-2006-0102481

(51) Int. Cl. G06F 9/44

(52) U.S. Cl. 717/170

(57) ABSTRACT

An information recording medium, in which a software version of an apparatus for reproducing contents is actively examined in order to provide update information about the software used in reproducing contents, the apparatus for reproducing contents, and a method of reproducing contents. The information recording medium includes contents and an active application which checks a version of software of an apparatus for reproducing the content and provides update information based on the checked version.

### CROSS-REFERENCE TO RELATED PATENT APPLICATION

This application claims the priority from Korean Patent Application No. 10-2006-0102481, filed on Oct. 20, 2006, in the Korean Intellectual Property Office, and U.S. Provisional Application No. 60/846,359, filed on Sep. 22, 2006, in the U.S. Patent and Trademark Office, the disclosures of which are incorporated herein in their entirety by reference.

### BACKGROUND OF THE INVENTION

1. Field of the Invention

Methods and apparatuses consistent with the present invention relate to an information recording medium, in which a software version of an apparatus for reproducing contents is actively examined in order to provide update information about the software of the reproduction apparatus used in reproducing contents.

2. Description of the Related Art

An apparatus for reproducing multimedia, such as a digital versatile disc (DVD) player, a Blu-ray disc (BD) player, or an MP3 player, may need to reproduce contents using a new function. For example, when the apparatus tries to reproduce digital contents encoded using new encoding standards, an error may occur in the apparatus, or content executing software of the apparatus may not be able to decode the digital content.

In the case of an apparatus connected to the Internet, software or firmware of the apparatus may be updated via an Internet network. However, when the digital contents are not reproduced in an apparatus that is not connected to the Internet, a user is unable to determine the reasons, even when the reason is that the content executing software should be updated. Accordingly, the user cannot use the newly made digital contents.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides an information recording medium, in which a software version of an apparatus for reproducing contents is actively examined in order to provide update information about the software used in reproducing contents, the apparatus for reproducing contents, and a method of reproducing contents.

According to an aspect of the present invention, there is provided an information recording medium including contents and an active application which checks a version of software of an apparatus for reproducing the content and provides update information based on the checked version.

Program code forming the active application may be intermediate code independent from a platform.

The active application may include program code which controls reproduction of the contents based on the checked version.

The active application may include program code which executes a function that makes the apparatus restore information about the version.

The active application may include program code for reading the information about the version stored in a predetermined storage space in the apparatus.

The active application may include information about versions of software by each apparatus model, required for checking the information about the version of software of the apparatus.

The active application may include program code for providing an update message informing about at least one of, for example, but not limited to, an update method, an update reason, an update occurrence time, and uniform resource locator (URL) information about where an update file is located, when the active application provides the update information based on the checked version.

The information recording medium may further include an update file for updating software of the apparatus, and the active application may include program code for updating the software of the apparatus by executing the update file based on the checked version.

According to another aspect of the present invention, there is provided an apparatus for reproducing contents recorded in an information recording medium, the apparatus including a reproduction unit which reproduces the contents using software of the apparatus, a reader which reads an active application for checking a version of the software of the apparatus and a controller which controls the reproduction unit in order to provide update information of the software when the software is required to be updated by interpreting and executing the active application.

According to another aspect of the present invention, there is provided a method of reproducing contents recorded in an information recording medium, the method including reading an active application for checking a version of software of an apparatus for reproducing the contents recorded in the information recording medium, checking whether the version needs to be updated by interpreting the active application and providing update information based on the checked version when the version needs to be updated.

### BRIEF DESCRIPTION OF THE DRAWINGS

The above and other aspects of the present invention will become more apparent by describing in detail exemplary embodiments thereof with reference to the attached drawings in which:

FIG. 1 is a diagram illustrating an information, recording medium having recorded thereon an active application according to an exemplary embodiment of the present invention;

FIG. 2 is a block diagram illustrating an apparatus for reproducing contents according to an exemplary embodiment of the present invention;

FIG. 3 is a flowchart illustrating a method of reproducing contents using an active application which checks a version of software of an apparatus for reproducing contents according to an exemplary embodiment of the present invention; and

FIG. 4 is a flowchart illustrating a method of reproducing contents using an active application which checks a version of software of an apparatus for reproducing contents according to another exemplary embodiment of the present invention.

### DETAILED DESCRIPTION OF THE EXEMPLARY EMBODIMENTS

Hereinafter, the present invention will be described more fully with reference to the accompanying drawings, in which exemplary embodiments of the invention are shown.

FIG. 1 is a diagram illustrating an information recording medium 100 having recorded thereor an active application according to an exemplary embodiment of the present invention. The information recording medium 100 includes contents 110 and an active application 120. The information recording medium 100 may be in various forms, for example, but not limited to, a DVD, a BD, or a flash memory.

The contents 110 denote multimedia contents, for example, but not limited to, photos, drawings, music, movies, games, etc. which are provided to a user by an apparatus for reproducing the contents 110. The contents 110 may include additional data, for example, but not limited to, menu constitution information and a multimedia data protection program, required for providing multimedia contents.

The active application 120 is a program for checking a version of software of the apparatus and providing update information based on the checked version.

The software of the apparatus in the present application includes firmware related to hardware, and is a program installed and operated in the apparatus in order to reproduce the contents 110. The software may be software for executing a central processing unit (CPU) of the apparatus or software for executing an encoder or decoder of the apparatus.

The active application 120 according to the current exemplary embodiment provides the contents 110 by using a contents provider and is generated in order to execute various operations in the apparatus. For example, an information recording medium manufactured by a company A includes contents A1 and an active application A2. When a main menu screen for providing the contents A1 includes a flash movie, a version of software of an apparatus for reproducing the contents A1 needs to be examined in order to check whether the apparatus can reproduce the flash movie. The active application A2 checks information about the version of the software and examines whether the apparatus can reproduce the flash movie. Also, the active application A2 can check the version of the software in order to check whether the software of the apparatus can execute various functions required for providing the contents A1.

Program code forming the active application 120 is an intermediate code independent from a platform. For example, the program code may be written in Java byte code in order to execute various operations. When the information recording medium 100 is a BD, the program code forming the active application 120 may be a BD+ code, which is a BD disc digital rights management scheme for protecting the contents 110.

In order to check the version of the software of the apparatus for reproducing the contents 110, the active application 120 may include program code which executes a function that makes the apparatus restore information about the version of the software or program code for reading the information about the version stored in a predetermined storage space of the apparatus.

The active application 120 includes the information about the version of the software of the apparatus in which the contents 110 of the information recording medium 100 can be reproduced. The information about the software version known by the active application 120 may be information about versions of software by apparatus model. The active application 120 may include information about at least one software version by a manufacturer or an apparatus model. For example, as information about a software version for executing contents 110, the active application may have a list of information about versions, such as “model name C—version C1, model name D—version D1, through to model name N—version N1”. Also, the active application 120 includes program code which determines whether the software needs to be updated by comparing a software version of each model and the version of the software of the apparatus actually installed in the information storage medium 100.

In order to provide the update information based on the checked software version, the active application 120 may include program code for providing an update message informing about at least one of, for example, but not limited to, an update method, an update reason that informs about a problem that might occur if the update is not performed, an update occurrence time that informs when an update file has been provided, and URL information about where the update file is located.

Also, the active application 120 may include program code which controls reproduction of the contents 110 based on the checked version. The information recording medium 100 further comprises the update file for updating the software of the apparatus, and the active application may further include program code for updating the software of the apparatus by executing the update file based on the checked software version.

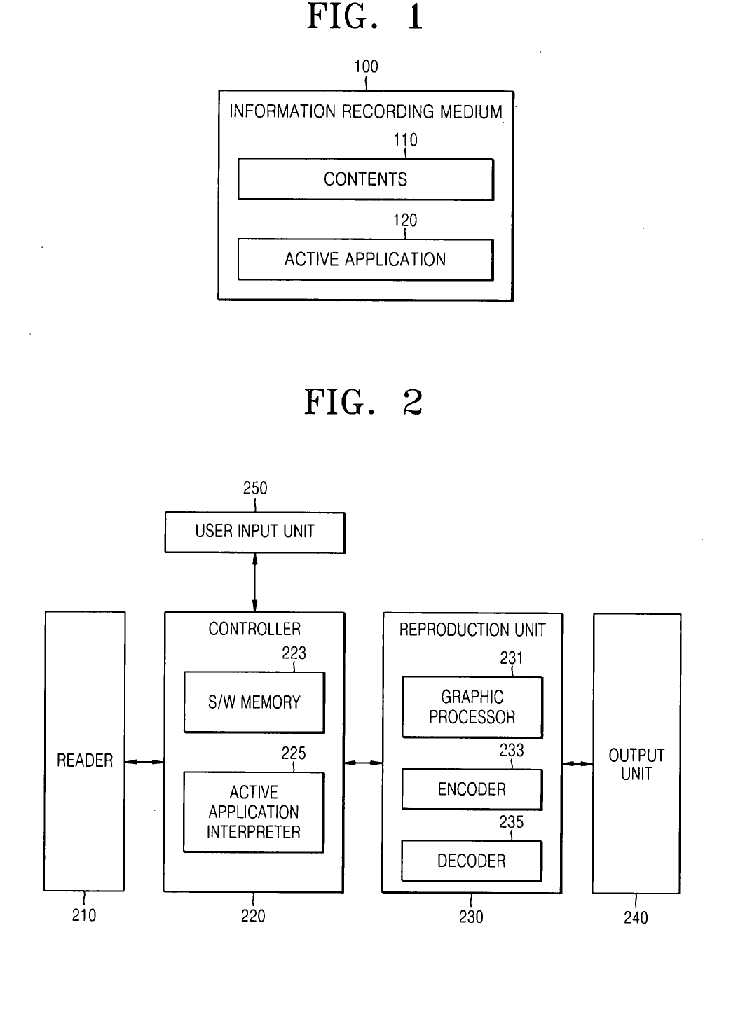

FIG. 2 is a block diagram illustrating an apparatus for reproducing contents according to an exemplary embodiment of the present invention. The apparatus includes a reader 210, a controller 220, a reproduction unit 230, an output unit 240, and a user input unit 250. Also, the apparatus is connected to an information recording medium (not shown) or the information recording medium is loaded in the apparatus in order for the apparatus to read and execute data recorded in the information recording medium.

The reader 210 checks a version of software of the apparatus and reads an active application which provides update information based on the checked software version.

The controller 220 may be formed of a CPU or a microprocessor which controls the overall operations of the apparatus by controlling data transmission/reception between each unit included in the apparatus. The controller 220 includes a software memory 223 which stores software or firmware required for reproducing the contents and information about the version of the software. The information about the version includes a model name and the version of the software or firmware.

The software memory 223 may store at least one piece of software required for reproducing the contents. When more than one piece of software is stored in the software memory 223, the active application and the apparatus should further include identification information for identifying each piece of software in order to check whether the software needs to be updated.

In order to reproduce the contents recorded in the information recording medium, the controller 220 controls the reproduction unit 230 to reproduce the contents using the software stored in the software memory 223. Also, the controller 220 includes an active application interpreter 225 which interprets the active application and controls the reproduction unit 230 based on the control of the active application.

Constitutions of the active application interpreter 225 may change based on the type of active application, as long as the active application interpreter 225 can interpret and execute the active application. For example, when the active application is formed of Java byte code, the active application interpreter 225 may be a Java virtual machine. Also, when the active application is formed of BD+ code, the active application interpreter 225 may be a BD+ virtual machine.

The reproduction unit 230 reproduces the contents recorded in the information recording medium using the software of the apparatus. The reproduction unit 230 includes a graphic processor which performs a graphic process for a graphic user interface (GUI), an MPEG encoder 233 and an MPEG decoder 235.

According to the current exemplary embodiment, the active application checks the version of the software of the apparatus using the following method. When the active application includes program code which executes a function that makes the apparatus restore information about the version of the software, the active application interpreter 225 interprets and executes the program code in order to restore the information about the version stored in the software memory 223. Also, when the active application includes program code which directly reads the information about the version stored in a predetermined storage space in the apparatus, the active application interpreter 225 interprets the program code and reads the information about the software version.

When the version of the software needs to be updated, the active application interpreter 225 controls the reproduction unit 230 to provide the update information based on the checked software version. For example, when the active application is interpreted and executed it is checked that the version of the software of the apparatus is “model name A—version 1.0”, and a version of the software required for completely reproducing the contents of the information recording medium is “model name A—version 2.0”. Accordingly, it is determined that the software of the apparatus needs to be updated and thus the update information is provided.

Here, the active application interpreter 225 may control the reproduction unit 230 to indicate an update message which informs about at least one of, for example, but not limited to, an update method, an update reason, an update occurrence time, and URL information about where an update file is located. For example, in order to provide the URL information about where an update file is located, an update message stating, “an update file can be downloaded from <www.xxxx>”, can be indicated.

The update information includes guide information about inquiring whether the contents are to be reproduced using the current software without updating the software. The guide information is provided to a user through the output unit 240, and when a user input informing that the contents should be reproduced using the current software without updating the software is received through the user input unit 250, the active application interpreter 225 controls the reproduction unit 230 to reproduce the contents that can be reproduced without updating the version of the software.

When the update file which can execute the update of the version of the software is recorded in the information recording medium, the active application interpreter 225 searches the update file f and executes program code for updating the software of the apparatus. Then, the active application interpreter 225 controls the reproduction unit 230 to reproduce the contents using the software updated by executing the active application.

The output unit 240 outputs audio and/or video data processed in the reproduction unit 230. The output unit 240 may include a speaker (not shown) and a display apparatus (not shown).

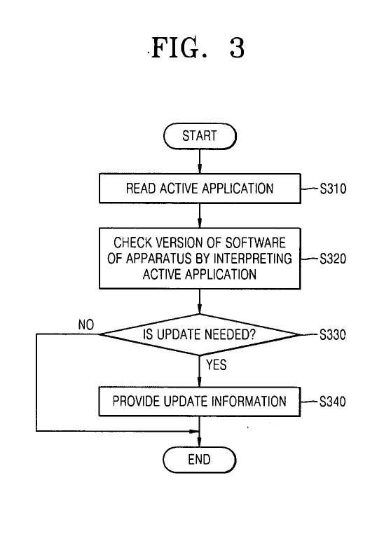

FIG. 3 is a flowchart illustrating a method of reproducing contents using an active application which checks a version of software of an apparatus for reproducing contents according to an exemplary embodiment of the present invention.

In operation S310, the active application is read. The active application is an application which checks the version of the software of the reproduction apparatus and provides update information based on the checked software version.

In operation S320, the active application is interpreted in order to check the version of the software. In the checking of whether the version of the software needs to be updated, program code included in the active application which executes a function that makes the apparatus restore information about the software version may be executed. Alternatively, program code included in the active application which reads the information about the software version stored in a predetermined storage space of the apparatus may be executed.

If it is determined that the version of the software needs to be updated in operation S330, update information is provided in operation S340 based on the checked software version. Operation S340 can be performed by indicating an update message informing about at least one of, for example, but not limited to, an update method, an update reason, an update occurrence time, and URL information about where an update file is located. If it is determined that the version of the software does not need to be updated in operation S330, the contents of the information recording medium is read via the current software of the apparatus.

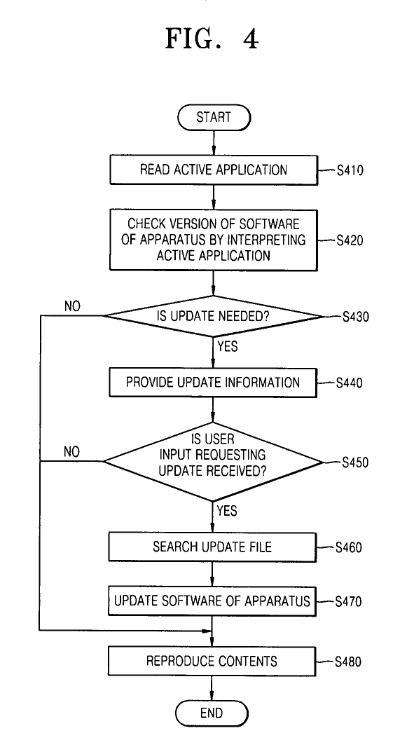

FIG. 4 is a flowchart illustrating a method of reproducing contents using an active application which checks a version of software of an apparatus for reproducing contents according to another exemplary embodiment of the present invention.

In operation S410, an active application is read. The active application is intermediate code independent from a platform, and is an application which checks a version of software of the apparatus and provides update information based on the checked software version.

In operation S420, the active application is interpreted and the version of the software is checked.

If it is determined that the version of the software needs to be updated in operation S430, the update information is provided in operation S440 based on the checked software version. In operation S440, guide information informing that an update file which can execute the update of the software is recorded in the information recording medium in which the active application is recorded, can be provided.

If a user input signal requesting to update the version is received in operation S450, the update file for updating the version of the software recorded in the information recording medium is searched for in operation S460. In operation S470, the software of the apparatus is updated by executing the update file. In operation S480, the contents are reproduced using the software updated by executing the active application.

If it is determined that the version of the software does not need to be updated in operation S430 or if the user input signal requesting to update the version is not received in operation S450, the contents can be reproduced using the current software of the apparatus in operation S480.

The invention can also be embodied as computer readable codes embodied on a computer readable recording medium. The computer readable recording medium is any data storage device that can store data which can be thereafter read by a computer system. Examples of the computer readable recording medium include, but are not limited to, read-only memory (ROM), random-access memory (RAM), CD-ROMs, magnetic tapes, floppy disks, optical data storage devices, and flash memory. The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

As described above, the version of the software used in reproducing the contents can be actively examined using the active application operable in the apparatus despite the type of hardware of the apparatus, and the update information about the software of the apparatus can be provided. Accordingly, when contents in a new type are to be reproduced, a user is able to clearly determine whether the software of the apparatus needs to be updated via an active program provided with the contents.

Also, the active application provided with the contents examines the version of the software, and thus the update information in various forms can be provided to the user. According to embodiments of the present invention, the active program formed of program codes which execute required operations based on the reproduced contents is provided, and thus the contents can be suitably reproduced by flexibly controlling the reproduction of the contents according to contents.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A computer-readable recording medium comprising:
contents; and
an active application which checks a version of software of an apparatus for reproducing the content and provides update information based on the checked version.

2. The computer-readable recording medium of claim 1, wherein program code forming the active application is intermediate code independent from a platform.

3. The computer-readable recording medium of claim 1, wherein the active application comprises program code which controls reproduction of the contents based on the checked version.

4. The computer-readable recording medium of claim 1, wherein the active application comprises program code which executes a function causing the apparatus to restore information about the version.

5. The computer-readable recording medium of claim 1, wherein the active application comprises program code for reading the information about the version stored in a storage space in the apparatus.

6. The computer-readable recording medium of claim 1, wherein the active application comprises information about versions of software by each apparatus model, required for checking the information about the version of software of the apparatus.

7. The computer-readable recording medium of claim 1, wherein the active application comprises program code for providing an update message informing about at least one of an update method, an update reason, an update occurrence time, and URL information about where an update file is located, when the active application provides the update information based on the checked version.

8. The computer-readable recording medium of claim 1, further comprising an update file for updating software of the apparatus, and
wherein the active application comprises program code for updating the software of the apparatus by executing the update file based on the checked version.

9. An apparatus for reproducing contents recorded in an information recording medium, the apparatus comprising:
a reproduction unit which reproduces the contents using software of the apparatus;
a reader which reads an active application for checking a version of the software of the apparatus; and
a controller which controls the reproduction unit in order to provide update information of the software when the software is required to be updated by interpreting and executing the active application.

10. The apparatus of claim 9, wherein program code forming the active application is an intermediate code independent from a platform and the controller comprises an active application interpreter which interprets and executes the program code.

11. The apparatus of claim 9, wherein the controller interprets and executes program code which executes a function causing the apparatus to restore information about the version.

12. The apparatus of claim 9, wherein the controller interprets and executes program code for reading the information about the version stored in the apparatus.

13. The apparatus of claim 9, wherein the controller controls the reproduction unit to indicate an update message informing about at least one of an update method, an update reason, an update occurrence time, and uniform resource locator information about where an update file is located.

14. The apparatus of claim 9, wherein the update information comprises guide information about inquiring whether the contents are to be reproduced using current software without updating the software, and the controller controls the reproduction unit to reproduce contents that can be executed without updating the version of the software of the apparatus, when a user input informing that the contents is to be reproduced using the current software without updating the software is received.

15. The apparatus of claim 9, wherein the controller executes program code which searches for an update file for updating the version of the software and updates the software by executing the update file, and controls the reproduction unit so that the reproduction unit reproduces the contents by using the software updated by executing the active application.

16. A method of reproducing contents recorded in an information recording medium, the method comprising:
reading an active application for checking a version of software of an apparatus for reproducing the contents recorded in the information recording medium;
checking whether the version needs to be updated by interpreting the active application; and
providing update information based on the checked version when the version needs to be updated.

17. The method of claim 16, wherein in the checking of whether the version of the software needs to be updated, the apparatus executes program code for reading information about the version.

18. The method of claim 16, wherein in the checking of whether the version of the software needs to be updated, the apparatus executes program code which executes a function that causes the apparatus to restore the information about the version.

19. The method of claim 16, wherein the providing of the update information based on the checked version is performed by indicating an update message informing about at least one of an update method, an update reason, an update occurrence time, and uniform resource locator information about where an update file is located.

20. The method of claim 16, wherein in the providing of the update information based on the checked version, the update information comprises guide information about inquiring whether the contents is to be reproduced using current software without updating the software, and
further comprising reproducing contents that can be executed without updating the version of the software of the apparatus, when a user input informing that the contents is to be reproduced using the current software without updating the software is received.

21. The method of claim 16, further comprising:
searching an update file for updating the version of the software recorded in the information recording medium;
updating the software of the apparatus by executing the update file; and
reproducing the contents using the software updated by executing the active application.
